(19) United States
(12) Patent Application Publication
(10) Pub. No.: US 2026/0012426 A1
(43) Pub. Date: Jan. 8, 2026

(54) ENGINE FOR PACKET ROUTING

(71) Applicant: MELLANOX TECHNOLOGIES, LTD., Yokneam (IL)

(72) Inventors: Eran Gil Beracha, Tel Aviv (IL); Aviv Kfir, Nili (IL)

(21) Appl. No.: 18/762,448

(22) Filed: Jul. 2, 2024

(51) Int. Cl. H04L 47/62; H04L 45/24; H04L 47/125

(52) U.S. Cl. CPC H04L 47/622; H04L 45/24; H04L 47/125

(57) ABSTRACT

A switch, device, and method of routing packets are provided. In one example, a switch includes one or more circuits to generate an inflated transmission queue (TQ) vector based on a subset of elements, use the inflated TQ vector to select an element from the subset of elements, and route a packet via an egress port based on the element selected from the subset of elements.

### FIELD OF THE DISCLOSURE

The present disclosure is generally directed toward networking and, in particular, toward networking devices, switches, and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. These interconnected entities form a network that enables data communication and resource sharing among the nodes. This feature, often referred to as multipath routing, allows data, often encapsulated in packets, to traverse different routes from a source device to a destination device. Such a network design enhances the robustness and flexibility of data communication, as it provides alternatives in case of path failure, congestion, or other adverse conditions. Moreover, it facilitates load balancing across the network, optimizing the overall network performance and efficiency.

However, managing multipath routing and ensuring optimal path selection can pose significant challenges. For instance, a few problems that may occur when routing a packet to a multipath destination are increased latency and decreased fairness. The issues of latency and fairness both create a desire to spread traffic between each of the destinations, which can ultimately minimize latency and improve fairness between the links. Facilitating the intelligent distribution of traffic between the destinations presents a challenge in itself.

### BRIEF SUMMARY

In accordance with one or more embodiments described herein, a computing system, such as a switch, may enable a diverse range of systems, such as switches, servers, personal computers, and other computing devices, to communicate across a network. Ports of the computing system may function as communication endpoints, allowing the computing system to manage multiple simultaneous network connections with one or more nodes.

Each port of the computing system may be associated with an egress queue of packets/data waiting to be sent via the port. In effect, each port may serve as an independent channel for data communication to and from the computing system. Packets to be sent via each port may be written to the queue associated with the port.

In the networking world, packets behave as queue elements and ports as a group of queues. Since queue occupancy for each port may vary as a function of time and traffic, some ports are a better choice for forwarding packets compared with others. To maintain load balancing across the queues and the network, many different types of packet-routing algorithms can be leveraged. Non-limiting examples of such algorithms include hash-based forwarding (HBF), weighted HBF, random, weighted random, pseudorandom, round robin, and weighted round robin. Different algorithms may perform better under certain network conditions.

Embodiments of the present disclosure provide a routing engine that is configured to utilize multiple algorithms (e.g., HBF, weighted HBF, random, weighted random, pseudorandom, round robin, and/or weighted round robin) and select a particular algorithm for use at a particular time, potentially based on current network conditions. According to at least some embodiments, a routing engine may be implemented to perform multiple algorithms that may help in routing or that may help other fields including the selection of an item from a set. As will be described herein, the proposed routing engine may be used to implement multiple routing algorithms (e.g., load balancers) partially or completely in hardware, thereby improving the speed of performance of the routing engine.

Round robin is a type of load balancer that helps spread queue elements between a group of queues. The weighted round robin is a load balancer that lets some queues get more queue elements compared with the rest, depending on some weight elements.

Random is a type of load balancer that spreads queue elements randomly, thereby maximizing fairness. The weighted random is a type of load balancer that utilizes weight elements to provide some queues with more elements as compared with others, but still utilizes a random number as the seed of the decision. A pseudorandom load balancer may be implemented similarly to random load balancer, but may utilize a seed generated with a pseudorandom number generator rather than a true or nearly-true random number generator. Random and pseudorandom may be used synonymously as some random number generators do not operate in a completely random manner.

HBF load balancers, as the name suggests, may be configured to utilize hashing as part of providing load balancing. An HBF or weighted HBF load balancer may hash incoming packets to one of a number of buckets, each of which corresponds to a particular forwarding behavior. Utilizing HBF load balancers helps to avoids issues having to do with maintaining state, and helps ensure flow affinity.

As described herein, a solution is provided herein that combines logic in a way such that hardware (e.g., a single hardware engine) can implement many types of load balancers (e.g., HBF, weighted HBF, random, weighted random, pseudorandom, round robin, and/or weighted round robin). The particular load balancer utilized by the hardware may be modified during operation of the switch and may change in response to network conditions.

The present disclosure discusses a system and method for enabling a switch or other computing system to route traffic or data to queues. Embodiments of the present disclosure aim to improve data flow efficiency and other issues by implementing an improved routing approach. The routing approach depicted and described herein may be applied to a switch, a router, or any other suitable type of networking device known or yet to be developed.

In an illustrative example, a switch is disclosed that includes one or more circuits configured to generate an inflated transmission queue (TQ) vector based on a subset of elements, use the inflated TQ vector to select an element from the subset of elements, and route a packet via an egress port based on the element selected from the subset of elements.

In another example, a device is disclosed that includes one or more circuits configured to receive a packet associated with a destination, generate an inflated TQ vector based on a subset of elements, use the inflated TQ vector to select an element from the subset of elements, and route the packet via an egress port based on the element selected from the subset of elements.

In yet another example, a method is disclosed that includes generating an inflated TQ vector based on a subset of elements, using the inflated TQ vector to select an element from the subset of elements, and routing a packet via an egress port based on the element selected from the subset of elements.

Any of the above example aspects may further include the subset of elements comprising a base TQ vector.

Any of the above example aspects may further include the one or more circuits being configured to select the subset of elements from a plurality of subsets of elements prior to generating the inflated TQ vector.

Any of the above example aspects may further include the plurality of subsets of elements including a time-bound subset of elements and a non-time-bound subset of elements.

Any of the above example aspects may further include the one or more circuits being configured to select the subset of elements from the plurality of subsets of elements based on input from a subset selector.

Any of the above example aspects may further include the inflated TQ vector is generated in response to receiving the packet via an ingress port.

Any of the above example aspects may further include the one or more circuits being configured to further to apply weighting logic to the subset of elements.

Any of the above example aspects may further include generating the inflated TQ vector by performing a thermometer coding on the subset of elements.

Any of the above example aspects may further include using the inflated TQ vector to select an element from the subset of elements by using one or more of a round robin algorithm, a random algorithm, and an HBF algorithm.

Any of the above example aspects may further include the one or more circuits being configured to receive a selection of one of the round robin algorithm, random algorithm, and the HBF algorithm.

Any of the above example aspects may further include the selection of the one of the round robin algorithm, random algorithm, and the hash-based forwarding algorithm is of one of the random algorithm and the hash-based forwarding algorithm, and where the one or more circuits are further configured to generate a sum of data in the inflated TQ vector and where the element is selected from the subset of elements based at least in part on the sum and one of a hash and a random number.

Any of the above example aspects may further include the hash being generated based on the subset of elements.

Any of the above example aspects may further include the selection of the one of the round robin algorithm, random algorithm, and the hash-based forwarding algorithm is of round robin and where the one or more circuits are further configured to select the element from the subset of elements based on a most recently selected element.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a switch in accordance with at least some embodiments of the present disclosure;

FIG. 2 is a block diagram depicting an illustrative configuration of switching hardware in accordance with at least some embodiments of the present disclosure;

FIG. 3 is a block diagram depicting an illustrative configuration of a computing network in accordance with at least some embodiments of the present disclosure;

FIG. 4 is a block diagram depicting an illustrative configuration of a data structure usable in accordance with at least some embodiments of the present disclosure; and

FIG. 5 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

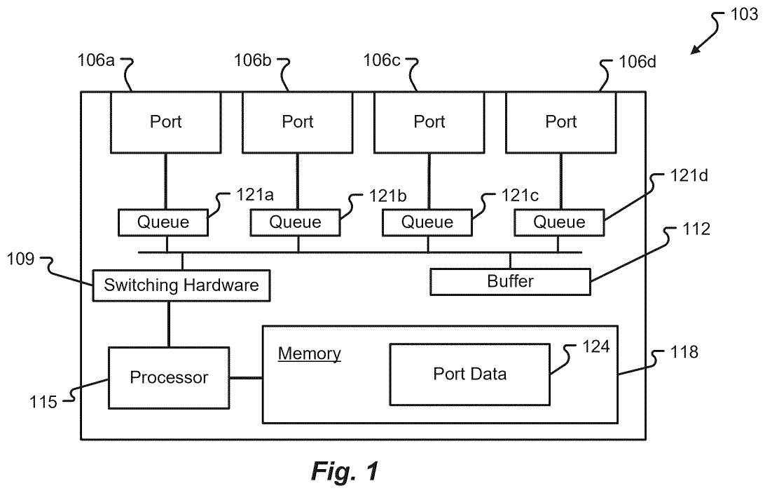

Referring now to FIGS. 1-5, various systems, and methods for routing packets between communication nodes will be described. The concepts of packet routing depicted and described herein can be applied to the routing of information from one computing device to another. The term packet as used herein should be construed to mean any suitable discrete amount of digitized information. The information being routed may be in the form of a single packet or multiple packets without departing from the scope of the present disclosure. Furthermore, it should be appreciated that the features and functions of a centralized architecture may be applied or used in a distributed architecture or vice versa.

In accordance with one or more embodiments described herein, a switch 103 as illustrated in FIG. 1 enables a diverse range of systems, such as switches, servers, personal computers, and other computing devices, to communicate across a network. While the computing device of FIG. 1 is described herein as a switch 103, it should be appreciated the computing device of FIG. 1 may be any computing device capable of sending data via ports 106a-d. Such a switch 103 as described herein may for example be a switch or any computing device comprising a plurality of ports 106a-d for connecting nodes on a network. In some embodiments, a switch 103 may be considered a part of a network.

The ports 106a-d of the switch 103 may function as communication endpoints, allowing the switch 103 to manage multiple simultaneous network connections with one or more nodes. Each port 106a-d may be used to transmit data associated with one or more flows or communication sessions. Each port 106a-d may be associated with a queue 121a-d enabling the port 106a-d to handle outgoing data packets associated with flows.

Each port 106a-d of the computing system has an egress queue 121a-d which may store data such as packets waiting to be sent via the port 106a-d. In effect, each port 106a-d may serve as an independent channel for data communication to and/or from the switch 103. Ports 106 allow for concurrent network communications, enabling the switch 103 to engage in multiple data exchanges with different network nodes simultaneously. As a packet or other form of data becomes ready to be sent from the switch 103, the packet may be assigned or written to a queue 121 from which the packet will be sent by the port 106.

The ports 106a-d of the switch 103 may be physical connection points which allow network cables such as Ethernet cables to connect the switch 103 to one or more network nodes.

As described herein, data, such as packets, may be sent via a particular one or more of the ports 106a-d selectively based on a number of factors. Switching hardware 109 of the switch 103 may comprise an internal fabric or pathway within the switch 103 through which data travels between the ports 106a-d. The switching hardware 109 may in some embodiments comprise one or more network interface cards (NICs). In some embodiments, each port 106a-d may be associated with a different NIC. The NIC or NICs may comprise hardware and/or circuitry which may be used to transfer data between ports 106a-d and queues 121a-d. As will be described in further detail herein, the switching hardware 109 may further include one or more logic blocks (e.g., functional blocks) that are configured to implement a number (e.g., a plurality) of different routing approaches. Illustratively and without limitation, the switching hardware 109 may include one or more of a thermometer coding block, a summation block, a modulo block, and an element selection block.

Switching hardware 109 may also or alternatively comprise one or more application-specific integrated circuits (ASICs) to perform tasks such as determining to which port a received packet should be sent. The switching hardware 109 may comprise various components including, for example, port controllers that manage the operation of individual ports, network interface cards that facilitate data transmission, and internal data paths that direct the flow of data within the switch 103. The switching hardware 109 may also include memory elements to temporarily store data and management software to control the operation of the hardware. This configuration could enable the switching hardware 109 to accurately track port usage and provide data to the processor 115 upon request.

Packets received by the switch 103 may be placed in a buffer 112 until being placed in a queue 121a-d before being transmitted by a respective port 106a-d. The buffer 112 may effectively be an ingress queue where received data packets may temporarily be stored. As described herein, the port or ports 106a-d via which a given packet is to be sent may be determined based on a number of factors.

The switch 103 may also comprise a processor 115, such as a central processing unit (CPU), a data processing unit (DPU), a graphics processing unit (GPU), a microprocessor, or any suitable circuit or device capable of reading instructions from memory 118 and performing actions. The processor 115 may execute software instructions to control operations of the switch 103.

The processor 115 may function as the central processing unit of the switch 103 and execute operative capabilities of the switch 103. The processor 115 may communicate with other components of the switch 103, such as switching hardware 109, such as to manage and perform computational operations.

The processor 115 may be configured to perform a wide range of computational tasks. Capabilities of the processor 115 may encompass executing program instructions, managing data within the system, and controlling the operation of other hardware components such as switching hardware 109. The processor 115 may be a single-core or multi-core processor and might include one or more processing units, depending on the specific design and requirements of the switch 103. The design of the processor 115 may allow for instruction execution, data processing, and overall system management, thereby enabling the switch's 103 performance and utility in various applications. Furthermore, the processor 115 may be programmed or adapted to execute specific tasks and operations according to application requirements, thus potentially enhancing the versatility and adaptability of the switch 103. Moreover, while certain functionality will be described in connection with the switching hardware 109, it should be appreciated that such functionality could be implemented by or within the processor 115. Alternatively or additionally, functionality described in connection the processor 115 may be implemented within the switching hardware 109.

The switch 103 may further comprise one or more memory 118 components. Memory 118 may be configured to communicate with the processor 115 of the switch 103. Communication between memory 118 and the processor 115 may enable various operations, including but not limited to, data exchange, command execution, and memory management. In accordance with implementations described herein, memory 118 may be used to store data, such as port data 124, relating to the usage of the ports 106a-d of the switch 103.

The memory 118 may be constituted by a variety of physical components, depending on specific type and design. Memory 118 may include one or more memory cells capable of storing data in the form of binary information. Such memory cells may be made up of transistors, capacitors, or other suitable electronic components depending on the memory type, such as dynamic random-access memory (DRAM), static random-access memory (SRAM), or flash memory. To enable data transfer and communication with other parts of the switch 103, memory 118 may also include data lines or buses, address lines, and control lines. Such physical components may collectively constitute the memory 118, contributing to its capacity to store and manage data, such as port data 124.

Port data 124, as which may be stored in memory 118, could encompass information about various aspects of port usage. Such information might include data about active connections, amount of data in queues 121, amount of data in the buffer 112, statuses of each port within the ports 106a-d, among other things. Port data 124 may include, for example, queue depths or occupancy, queue grades, distant link information, a number of total ports 106a-d, and a queue size or length for each queue 121a-d associated with each port 106a-d, as described in greater detail below. The stored port data 124 may be accessed and utilized by the processor 115 in managing port operations and network communications. For example, the processor 115 might utilize the port data 124 to manage network traffic by generating a queue vector mask which may be used by switching hardware 109 to direct data to queues 121a-d of the switch 103 as described in greater detail below. Therefore, the memory 118, in potential conjunction with the processor 115, may play a crucial role in optimizing the usage and performance of the ports 106 of the switch 103.

In one or more embodiments of the present disclosure, a processor 115 or switching hardware 109 of a switch 103 may execute polling operations to retrieve data relating to activity of the queues 121a-d, such as by polling the queues 121a-d, the buffer 112, the port data 124, the switching hardware 109, and/or other components of the switch 103 as described herein. As used herein, polling may involve the processor 115 periodically or continuously querying or requesting data from the switching hardware 109 or may involve the processor 115 or the switching hardware 109 periodically or continuously querying or requesting data from the queues 121a-d or from memory 118. The polling process may in some implementations encompass the processor 115 sending a request to the switching hardware 109 to retrieve desired data. Upon receiving the request, the switching hardware 109 may compile the requested queue data and send it back to the processor 115.

If a packet stored in the buffer 112 has a particular destination address, and multiple ports 106a-d lead to the destination address, the switching hardware 109 may be required to make a determination as to from which of the multiple ports 106a-d leading to the destination address the packet should be sent. Based on the determination as to from which of the multiple ports 106a-d leading to the destination address the packet should be sent, the switching hardware 109 may write the data of the packet to a respective queue 121a-d. For example, if a first port 106a and a second port 106b lead to the destination address of the packet, the switching hardware 109 may determine whether to write the packet to a first queue 121a associated with the first port 106a, a second queue 121b associated with the second port 106b, or both queues 121a-b. Decisions related to which queue receives a particular port may be made based on a particular routing logic applied by the switching hardware 109.

The memory 118 may also store information about the queues 121a-d, the buffer 112, and/or other components, such as may be generated or determined by the switching hardware 109, the processor 115, or other components of the switch 103. Such information may be stored in the memory 118 as port data 124. Port data 124 may comprise, but should not be considered as limited to, depths of each of the queues 121a-d, weights for each queue, grades of each queue, an indication of which destination addresses are served by each port 106a-d, a size of each queue 121a-d, historical port data information, information about remote links, and/or any other information relating to the transfer of data to and from the switch 103 as described herein.

Port data 124 may include various metrics such as amount of data or a number of packets in each queue 121a-d, weighting information, queue grade information, and/or other information, such as data associated with other devices with which the switch 103 communicates. The processor 115, after receiving such data, might perform further operations based on the obtained information, such as optimizing port usage by determining queue weights and generating queue vector masks as described herein.

The processor 115 may also be capable of receiving information from remote peers such as other switches or devices. Such information may indicate a quality associated with a queue of the remote peer. For example, if a queue of a remote peer is congested or inactive, the remote peer can send information to the switch 103 indicating the queue is congested or inactive. The processor 115 may store such information and/or use such information to generating routing instructions for the switch 103.

The switch 103 may also be capable of generating information to share with remote peers to indicate to the remote peers a quality of each of the queues 121a-d, such as whether any one or more of the queues 121a-d are congested or inactive. After generating the information to share with remote peers, the information may be sent via one or more of the ports 106a-d to be received by one or more remote peers.

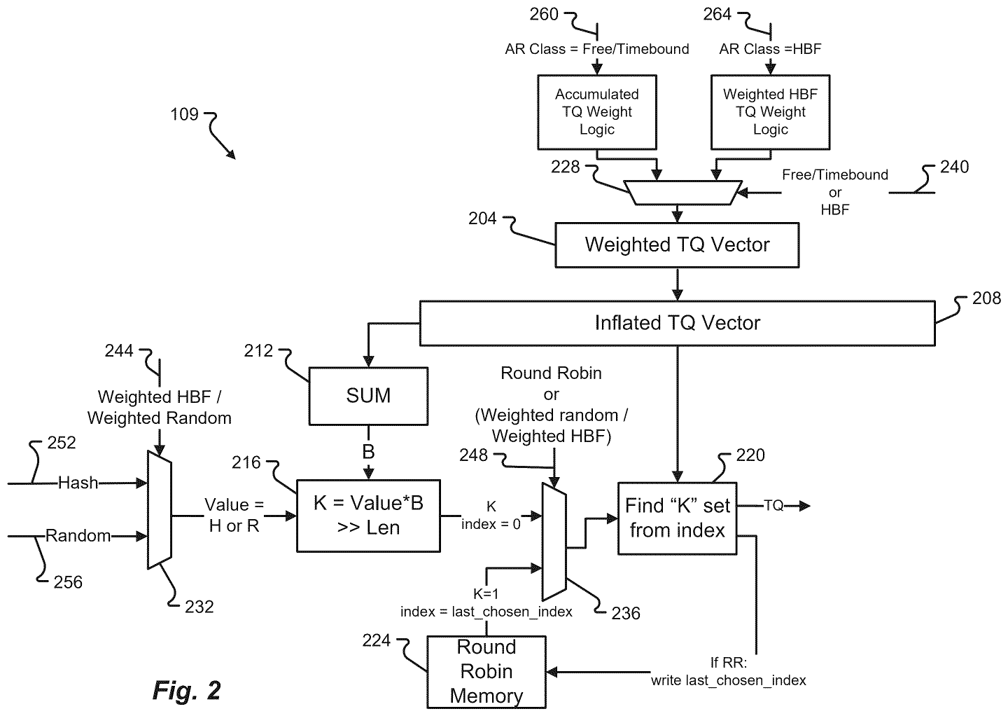

With reference now to FIG. 2, additional details of the switching hardware 109 will be described in accordance with at least some embodiments of the present disclosure. The switching hardware 109 is illustrated to include a number of functional blocks in a particular configuration. It should be appreciated that embodiments of the present disclosure are not limited to the specific configuration illustrated in FIG. 2, but that other configurations of elements are possible.

The switching hardware 109 is shown to include a number of blocks including, without limitation, a thermometer coding block 208, a summation block 212, a modulo block 216, and a selection block 220. The input to the thermometer coding block 208 may include a weighted TQ vector 204, which is output by a subset selector 228. The subset selector 228 is operated by a subset selector signal 240, which indicates whether a free/timebound routing logic is to be applied or an HBF routing logic is to be applied. If the subset selector signal 240 indicates that the free/timebound routing logic is to be applied, then an accumulated TQ weight logic 260 is used as a selected subset. If the subset selector signal 240 indicates that the HBF routing logic is to be applied, then a weighted HBF TQ weight logic 264 is used as a selected subset. In other words, the subset selector signal 240 is used to determine the subset that will be used to apply the choosing algorithm.

The weighted TQ vector 204 is selected from the subsets 260, 264, based on the subset selector signal 240, and provided to the thermometer coding block 208. The thermometer coding block 208 may correspond to a hardware block that takes an integer with the size of n bits, and transforms the integer into a vector where the number of set bits are equal to the integer value, and the length of the vector is 2ⁿ. For example, if n=2, and the integer is 3, then the output of the thermometer coding block 208 will be 1110.

The output of the thermometer coding block 208 is provided to a summation block 212 and to the selection block 220. The summation block 212 may correspond to a hardware block that receives a vector with a length of N*2ⁿ bits and returns the number of set bits therein. The output of the summation block 212 may be provided to the modulo block 216.

In addition to receiving the output from the summation block 212, the modulo block 216 may also receive an output from a hash or random selector 232. The hash or random selector 232 may be operated by a hash or random selection signal 244, which determines if a hash value 252 or a random (or pseudorandom) value 256 are provided as an output of the hash or random selector 232 to the modulo block 216. The hash value 252 may be calculated on the object that triggered the switching hardware 109, such as a forwarding packet used for the HBF algorithm. The random value 256 may correspond to an output of a random or pseudorandom number generator.

The modulo block 216 may correspond to a hardware block that is implemented using a multiplier and a right shift operator. In some embodiments, the modulo block 216 may receive the output of the summation block 212, which may include the Hash or Random value and the size of the Hash or Random value. In operation, the modulo block 216 may implement the following functionality: K=Value*B>>Len, where “Value” is denoted as the hash or random value coming from the user input, where “B” is denoted as the output of the summation block 212 indicating the number of set bits, where “Len” is denoted as the number of bits of the Hash or Random input, and where “K” is denoted as the modulo result (e.g., output of the modulo block 216).

The functionality provided by the modulo block 216 helps with the fairness of the algorithm since K is in the range of [0 . . . Len], which effectively performs the linear transformation of 2^{Len}→Len, the ratio (2^{Len})/(N*2ⁿ) determines the fairness of the algorithm, the bigger Len is, the smaller the fairness error of the algorithm.

The output of the modulo block 216 is provided as an input to an algorithm selector 236. The algorithm selector 236 may be operated by an algorithm selection signal 248, which may cause the algorithm selector 236 to choose between its first input (the output of the modulo block 216) and its second input (the output of a round robin memory block 224). The algorithm selection signal 248 may The round robin memory block 224 may include a memory device having at least log2(N) bits. The output of round robin memory block 224 may include a K value equal to one and an index corresponding to a last chosen index. The round robin memory block 224 may operate within a feedback loop by receiving an output from the selection block 220. Specifically, the selection block 220 may provide the last chosen index to the round robin memory block 224 if the round robin routing algorithm is utilized.

The algorithm selector 236 may correspond to a hardware block that receives an integer K and a vector of size N*2ⁿ and returns the index of the K set element in the vector. When the Round Robin algorithm is selected as determined based on the algorithm selection signal 248, K=0. When Random/HBF algorithms are selected based on the algorithm selection signal 248, K is the result of the modulo block 216. The selection block 220 may provide an output TQ that includes the index of the chosen element (e.g., the final result of the algorithm). The output of the selection block 220 may represent the chosen element from the selected subgroup of elements. In some embodiments, the output of the selection block 220 is also written to the round robin memory block 224, which is then provided as feedback to the algorithm selector 236.

The switching hardware 109 depicted in FIG. 2 represents a configuration of hardware that minimizes costs and maximizes the number of routing algorithms supported by the switching hardware 109. In particular, the switching hardware 109, in some embodiments, may correspond to a single hardware unit capable of supporting many different types of routing algorithms (e.g., HBF, weighted HBF, random, weighted random, pseudorandom, round robin, and/or weighted round robin).

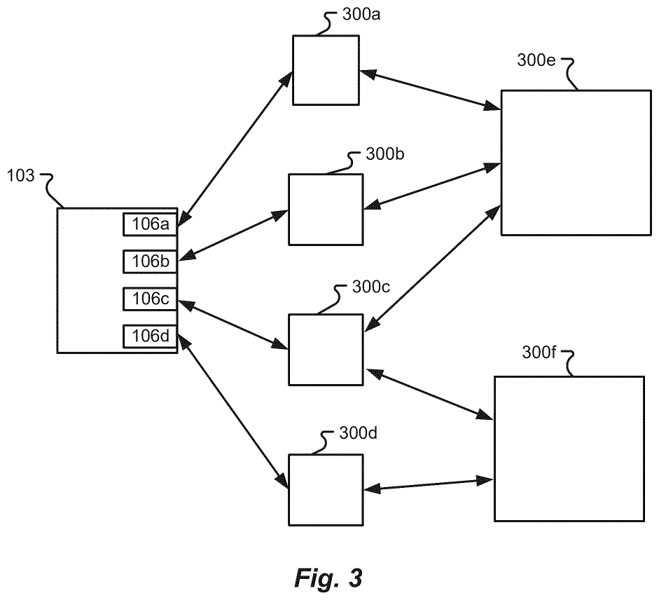

As illustrated in FIG. 3, a switch 103 may be connected to a number of nodes 300a-f, forming a network. For example, the systems and methods described herein may comprise a plurality of interconnected switches. Multiple switches 103, or other computing devices, can be interconnected in a variety of topologies, such as star, ring, or mesh, depending upon the specific requirements and resilience needed for the network. For instance, in a star topology, a plurality of switches may be connected to a central switch, whereas in a ring topology, each switch may be connected to two other switches in a closed loop. In a mesh topology, each switch may be interconnected with every other switch in the network. These robust structures afford a level of redundancy, as there are multiple paths for data to travel, ensuring that network functionality can be maintained even in the event of a switch failure.

Each node 300a-f may be a switch such as the switch 103 illustrated in FIG. 1 or any type of computing device. Each port 106a-d may be connected to the same or a different node 300a-d. In the example illustrated in FIG. 3, a first port 106a is connected to a first node 300a, a second port 106b is connected to a second node 300b, a third port 106c is connected to a third node 300c, and a fourth port 106d is connected to a fourth node 300d. A fifth node 300e is connected to the first, second, and third nodes 300a-c, and a sixth node 300f is connected to the third and fourth nodes 300c-d.

For a packet to travel from the switch 103 to the first node 300a, the packet must be sent via the first port 106a. For a packet to travel from the switch 103 to the second node 300b, the packet must be sent via the second port 106b. For a packet to travel from the switch 103 to the third node 300c, the packet must be sent via the third port 106c. For a packet to travel from the switch 103 to the fourth node 300d, the packet must be sent via the fourth port 106d. For a packet to travel from the switch 103 to the fifth node 300e, the packet must be sent via one or more of the first, second, and third ports 106a-c. The first, second, and third nodes 300a-c may be considered as hop switches for packets sent to the fifth node 300e. For a packet to travel from the switch 103 to the sixth node 300f, the packet must be sent via one or both of the third and fourth ports 106c-d. The third and fourth nodes 300c-d may be considered as hop switches for packets sent to the sixth node 300f. A packet with a destination address of the fifth node 300e may be sent via any of ports 106a-c while a packet with a destination address of the sixth node 300f may be sent via either the third or fourth port 106c-d. It should be appreciated that each of the arrows connecting the nodes 300a-d to nodes 300e-f may represent any number of one or more connections via one or more ports of each node 300a-f.

In some implementations, the functionality of the switch 103 may support the routing decisions made to direct a packet toward its destination. As noted above, the switch 103 may be configured to utilize a number of different types of routing algorithms that minimize latency and/or maximize fairness. Ultimately, the type of routing algorithm utilized by the switch 103 may be selected to support an improved performance of the overall network.

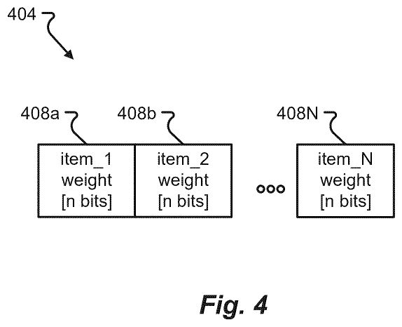

With reference to FIG. 4, additional details of a data structure 404 that may be provided as an input to the switching hardware 109 will be described in accordance with at least some embodiments of the present disclosure. The data structure 404 may represent the input(s) 260, 264 provided to the subset selector 228. In some embodiments, the data structure 404 includes a number of subsets. More specifically, but without limitation, the data structure 404 includes S numbers of weighted subsets 408a-N, where each subset is formatted according to the following: a total of N*n numbers of bits where N is the index of the last item in the subset and n is the number of bits representing the weight of each element in the subset 408.

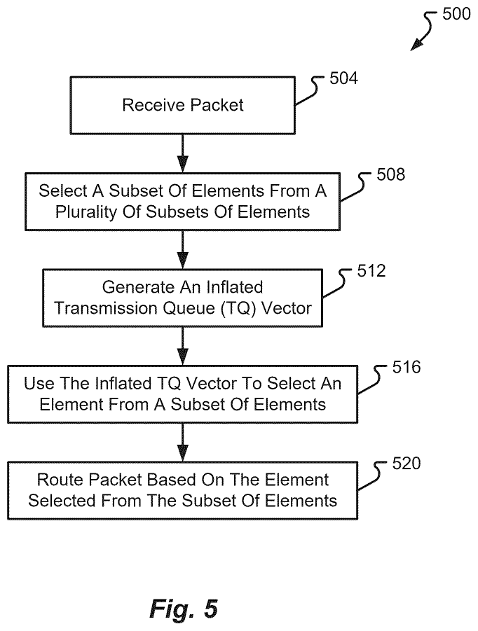

As illustrated in FIG. 5, a method 500 as described herein may be performed by a switch 103 in accordance with one or more of the embodiments described herein. The method 500 involves generating a routing vector and/or mask comprising a weight for each of a plurality of ports. The routing vector or mask is used by switching hardware 109 to route packets to queues 121a-d, where each queue 121a-d is associated with a port 106a-d, and each port 106a-d is associated with one or more destinations or nodes 300 as illustrated in FIG. 3.

While the features of the method 500 are described as being performed by switching hardware 109, it should be appreciated that the functions may be performed by switching hardware 109, a processor 115, or any other computing device in or in communication with a switch 103. The switch 103 comprises a plurality of ports 106a-d. Each port 106a-d is associated with a respective queue 121a-d.

In one or more embodiments of the present disclosure, the method 500, after executing, may return to step 504 and recommence or repeat the method. In some implementations, the repetition of method 500 may occur without delay. In such cases, as soon as the method 500 concludes, the method 500 may immediately begin a next iteration. This arrangement could allow for a continuous execution of method 500. In some implementations, a pause for a predetermined amount of time may occur between successive iterations of method 500. The duration of the pause may be specified as per the operational needs of the method such as by a user.

The method 500 starts when a packet is received at a switch 103 or similar type of communication device (step 504). In some embodiments, the packet may be received at a port 106 of a switch 103. In some embodiments, a packet may be received at some other component of the switch 103 (e.g., a queue 121, buffer 112, switching hardware 109, processor 115, or memory 118). In some embodiments, the packet may be associated with a destination (e.g., may be directed toward a defined destination).

The method 500 continues by selecting a subset of elements from a plurality of subsets of elements (step 508). The subset of elements may be selected a plurality of subsets of elements that include S numbers of weighted subsets.

The method 500 continues by generating an inflated TQ vector (step 512). In some embodiments, generating an inflated TQ vector may include receiving an integer with the size of n bits, and transforming the integer into a vector where the number of set bits are equal to the integer value, and the length of the vector is 2ⁿ.

The method 500 continues by using the inflated TQ vector to select an element from the subset of elements (step 516). In some embodiments, a selection block 220 may utilize the TQ vector to gets an integer K and a vector of size N*2ⁿ and return the index of the K set element in the vector.

The method 500 may then continue by routing the packet based on the element selected from the subset of elements (step 520). In some embodiments, the selected element is utilized to select a routing algorithm that is used to make a routing decision with respect to the packet.

The present disclosure encompasses methods with fewer than all of the steps identified in FIG. 5 (and the corresponding description of the method), as well as methods that include additional steps beyond those identified in FIG. 5 (and the corresponding description of the method). The present disclosure also encompasses methods that comprise one or more steps from the methods described herein, and one or more steps from any other method described herein.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A switch, comprising one or more circuits to:
generate an inflated transmission queue (TQ) vector based on a subset of elements;
use the inflated TQ vector to select an element from the subset of elements; and
route a packet via an egress port based on the element selected from the subset of elements.

2. The switch of claim 1, wherein the subset of elements comprises a base TQ vector.

3. The switch of claim 1, wherein the one or more circuits are further to select the subset of elements from a plurality of subsets of elements prior to generating the inflated TQ vector.

4. The switch of claim 3, wherein the plurality of subsets of elements includes a time-bound subset of elements and a non-time-bound subset of elements.

5. The switch of claim 3, wherein the one or more circuits select the subset of elements from the plurality of subsets of elements based on input from a subset selector.

6. The switch of claim 1, wherein the inflated TQ vector is generated in response to receiving the packet via an ingress port.

7. The switch of claim 1, wherein the one or more circuits are further to apply weighting logic to the subset of elements.

8. The switch of claim 1, wherein generating the inflated TQ vector comprises performing a thermometer coding on the subset of elements.

9. The switch of claim 1, wherein using the inflated TQ vector to select an element from the subset of elements comprises using one or more of a round robin algorithm, a random algorithm, and a hash-based forwarding algorithm.

10. The switch of claim 9, wherein the one or more circuits are further to receive a selection of one of the round robin algorithm, random algorithm, and the hash-based forwarding algorithm.

11. The switch of claim 10, wherein the selection of the one of the round robin algorithm, random algorithm, and the hash-based forwarding algorithm is of one of the random algorithm and the hash-based forwarding algorithm, and wherein the one or more circuits are further to generate a sum of data in the inflated TQ vector and wherein the element is selected from the subset of elements based at least in part on the sum and one of a hash and a random number.

12. The switch of claim 11, wherein the hash is generated based on the subset of elements.

13. The switch of claim 10, wherein the selection of the one of the round robin algorithm, random algorithm, and the hash-based forwarding algorithm is of round robin and wherein the one or more circuits are further to select the element from the subset of elements based on a most recently selected element.

14. A device, comprising one or more circuits to:
receive a packet associated with a destination;
generate an inflated transmission queue (TQ) vector based on a subset of elements;
use the inflated TQ vector to select an element from the subset of elements; and
route the packet via an egress port based on the element selected from the subset of elements.

15. The device of claim 14, wherein the subset of elements comprises a base TQ vector.

16. The device of claim 14, wherein the one or more circuits are further to select the subset of elements from a plurality of subsets of elements prior to generating the inflated TQ vector.

17. The device of claim 16, wherein the plurality of subsets of elements includes a time-bound subset of elements and a non-time-bound subset of elements.

18. The device of claim 16, wherein the one or more circuits select the subset of elements from the plurality of subsets of elements based on input from a subset selector.

19. The device of claim 14, wherein the inflated TQ vector is generated in response to receiving the packet via an ingress port.

20. A method, comprising:
generating an inflated transmission queue (TQ) vector based on a subset of elements;
using the inflated TQ vector to select an element from the subset of elements; and
routing a packet via an egress port based on the element selected from the subset of elements.
